(19) United States
(12) Patent Application Publication
(10) Pub. No.: US 2006/0291632 A1
(43) Pub. Date: Dec. 28, 2006

(54) Automated Cabin Queue System

(76) Inventor: Michael Kwame Mpare, Spokane, WA (US)

Correspondence Address: MICHAEL MPARE, 5435 N. GREENWOOD BLVD., SPOKANE, WA, 99205, US

(21) Appl. No.: 11/160,444

(22) Filed: Jun. 23, 2005

(51) Int. Cl. H04M 1/64

(52) U.S. Cl. 379/88.22

(57) ABSTRACT

ACQS is an intelligent built-in system that will monitor the flow of traffic through the aisle of the cabin. Each passenger seat will have an interactive control pad that will alert the passenger when it's best to move freely in the cabin. One of the main objectives of this system will be to check flow to and from the lavatories.

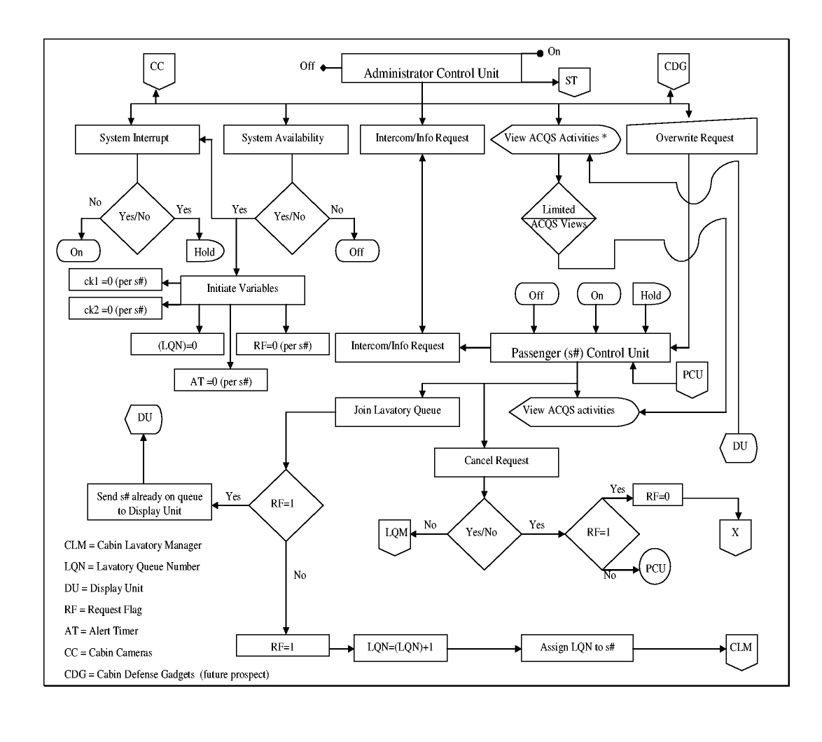

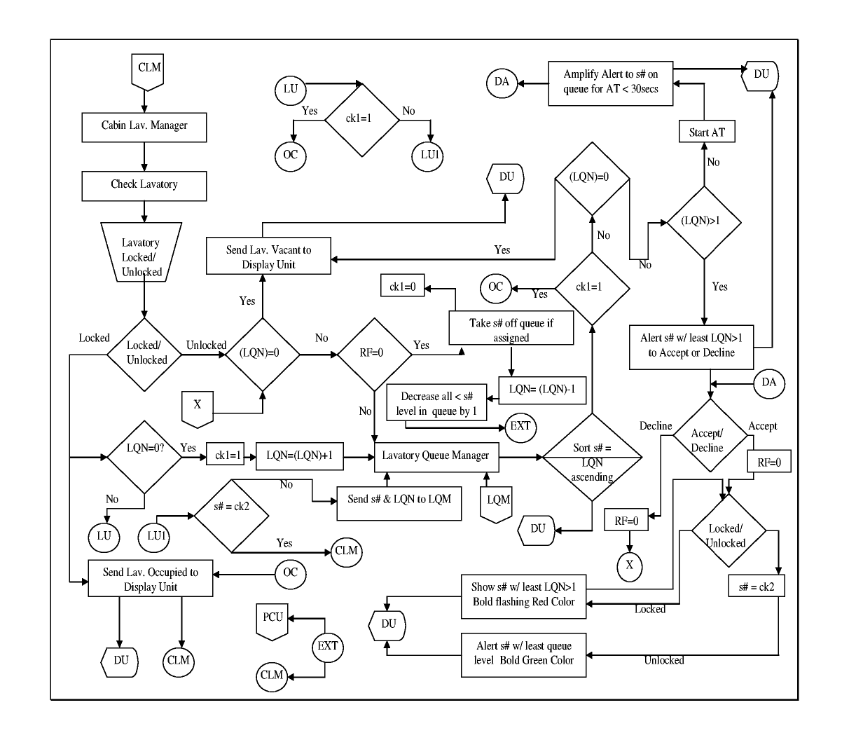

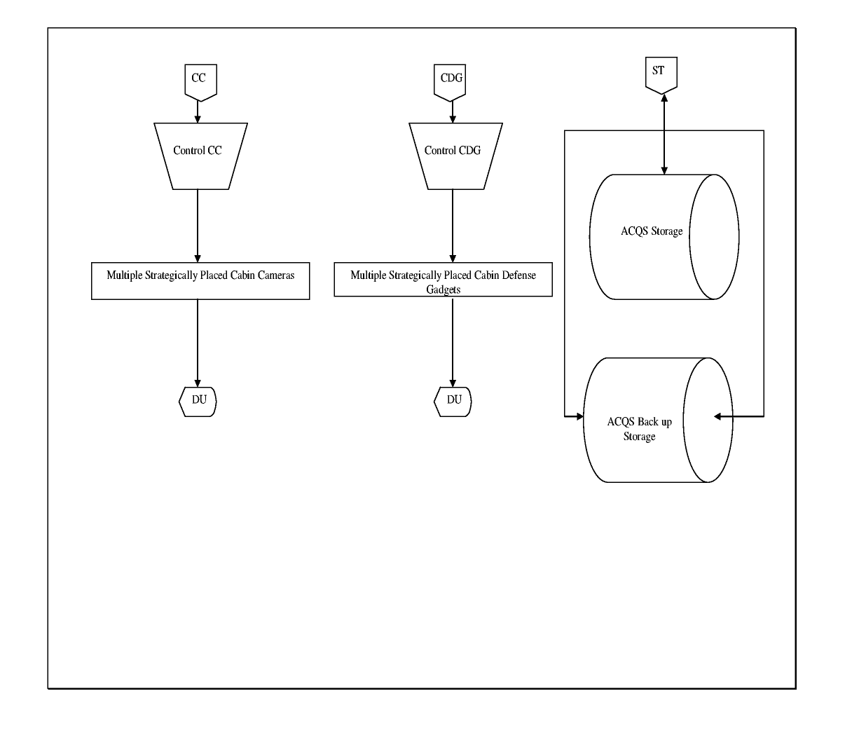

The Automated Cabin Queue System (ACQS) is designed to be integrated into the cabin communication system in the Private (if applicable)/Commercial Airplane Group. ACQS could therefore be incorporated into the Passenger Service System (reading/attendant call system) and will be able to manage movements in all parts of the cabin (with respect to passengers) which could pose a security/safety hazard for an entire flight. ACQS consists of two units, the Administrator Control and Passenger Control Units.

Administrator Control Unit: Monitor and set current settings of ACQS system. This includes: System Availability (Shut down): The Administrator will have the choice to shut down the ACQS system or have it turned on. As soon as ACQS is turned on all the necessary variables needed for process operations will be initialized (i.e. set the Request Flag (RF), Alert Timer (AT), and Lavatory Queue Number (LQN) to zero). A signal is then sent to the System Interrupt unit to check its current status. System Interrupt: Through this unit the Administrator can hold/pause all operations and requests in the ACQS system without shutting the whole system down or canceling current operations or processes. When ready, the Administrator can just turn the system On to resume all functions, processes and operations. Intercom/info Request: This unit will have a two-way functionality between the Administrator and the entire passenger control unit. It will have a basic call button, an emergency button, and an urgent request button. The Administrator will also be able to link communication between passengers in different seats upon request. And because of security reasons all these communications can be monitor with the passenger's privacy highly respected. Overwrite passenger request: The Administrator will have the rights to overwrite a passengers request as needed to ensure the manageability of the ACQS system and help decrease the security risks of the crew. Monitor all ACQS Activities: The Administrator will have a display that will be able to show every single activity of the ACQS system. From these displays the Administrator can filter out the views necessary for the passengers and relay it to the passenger display screens. Control Cabin Cameras: This unit allows the Administrator to control multiple strategically placed cameras in the cabin area. The cameras will be placed inconspicuously at these strategic locations. Cabin Defense Gadgets (possible future prospect): These will be defense gadgets, allowed by appropriate authority, also inconspicuous and placed at strategic locations in the cabin and controlled be Administrator and password protected. The Administrator can remotely control these gadgets in self defense to bring down any treat in the cabin without fatal results.

All these activities of the ACQS system will be automatically sent to a storage unit that will be able to transmit the data to an assigned and equipped ground unit at the different airports or offices.

Passenger Request/Control Pad: Using a control/request pad/screen each passenger will be able to view/know the current status of the ACQS system. Also each passenger control unit (PCU) is assigned per seat number (s#). Therefore each PCU will be able to request a respective position on the queue for that seat, depending on the number in the queue, check current status on the queue and automatically take its position off the queue as soon as the passenger on using the PCU is done using the lavatory. Also the passenger using the PCU can request to be taken off the queue. The functions of the PCU described in more detail are as follows. View ACQS Activities: Each passenger will be able to view the current status of the ACQS system as allowed by the system Administrator. Any alerts sent through the ACQS system will also be seen on this unit. Join Lavatory Queue: When necessary, each passenger can request to use the lavatories. The ACQS system will show through the displays which lavatory is vacant or occupied. As soon as a passenger requests to join the lavatory queue, the ACQS system will verify the Request Flag of that seat number. If the Request Flag is already invoked (i.e. equals one), ACQS will send an alert message to the Administrator and Passenger display screen that s# is already on the lavatory queue. If the Request Flag (RF) is not assigned (i.e. equals zero), ACQS will invoke RF, increase number in the queue (LQN) by one, assign s# to the LQNth position in the queue, and send the request to the Cabin Lavatory Manager (CLM) unit. CLM then checks if the lavatory is locked (occupied) or unlocked (vacant). If locked, the CLM unit then verifies the Lavatory Queue number to make sure it reflects at least one person on the queue. If the number reflects zero number of people on the queue, CLM will increase the number in the queue by one and send this information to the display unit. If another passenger requests to join the queue, ACQS will assign his passenger the next least position available on the queue. Should the passenger decided to cancel his/her request, they will be asked to verify the cancellation request. Ones verified, the request is sent to CLM unit which will go through the queue and take that seat numbers (s#) position out of the queue and decrease all positions greater than the s# that requested the cancellation by one. The person next to go in line within the queue will also receive an alert warning about them being the next to go as soon as the lavatory is unlocked. With this alert signal will also be an Accept or Decline request. Here if the passenger who is next in line, for some reason decides not to go to the lavatory, can decline the request and be taken off the queue. CLM will then go through the queue again and shift all positions respectfully until an unlock sequence is received. As soon as an unlock signal is received by the CLM unit it first checks to see if there is any one waiting on the queue. If there is no passenger on the queue (i.e. LQN equals zero) it sends out a lavatory vacant signal to the displays unit (DU) which can be viewed by the Administrator and passengers. CLM then takes the passenger/s# off the queue and then rearrange the queue to reflect the change. If the queue is not empty CLM will go through the whole process again until everyone on the queue have their respective turn to the lavatory, all this while keeping the aisles free for the Airhosts and Airhostesses to maneuver freely and decreasing any security risk to the entire crew.

What is claimed is:

1. I claim Rights to the intellectual property this design.

2. Any marketing or manufactured product that results from this invention/design.

3. Full protection of copyright to patent.
